(19) United States
(12) Patent Application Publication
(10) Pub. No.: US 2006/0288608 A1
(43) Pub. Date: Dec. 28, 2006

(54) AUTOMATIC CLOTHES DRYER

(76) Inventors: James P. Carow, St. Joseph, MI (US); Mark E. Glotzbach, Mishawaka, IN (US)

Correspondence Address: MCGARRY BAIR PC, 171 MONROE AVENUE, N.W., SUITE 600, GRAND RAPIDS, MI, 49503, US

(21) Appl. No.: 11/160,433

(22) Filed: Jun. 23, 2005

(51) Int. Cl. F26B 11/02

(52) U.S. Cl. 34/604; 34/606

(57) ABSTRACT

An automatic clothes dryer comprises a cabinet defining an interior space in which is rotatably mounted a drum that defines a drying chamber, a heater assembly having a heating element for heating air, and a motor for rotating the drum. A blower is mounted within the interior space and is fluidly coupled to the drying chamber for moving heated air through the drying chamber. A first temperature sensor is mounted upstream of the heating element. A second temperature sensor is mounted downstream of the blower. Outputs from the temperature sensors are utilized with one or more algorithms to determine the air flow characteristics through the dryer.

### FIELD OF THE INVENTION

The invention relates generally to automatic clothes dryers. In one aspect, the invention relates to a sensor assembly for an automatic clothes dryer which is initially operated for a preselected time prior to initiation of a drying cycle. The sensor output is evaluated to determine whether the dryer is set up and operating properly. The results are available to a consumer as a visual output or stored for later retrieval by a service technician.

### DESCRIPTION OF THE RELATED ART

Automatic clothes dryers are well known, and typically comprise a cabinet enclosing a horizontally rotating drum accessible through an access door at the front of the cabinet for holding clothing items to be dried. Rotation of the drum is driven by a motor. The motor can also drive a blower or fan which delivers dry, heated or unheated air to the drum for drying the clothing items. Alternatively, the blower can be driven by a separate motor. A heater is typically positioned in an air inlet assembly upstream of the drum for heating the drying air prior to its entry into the drum. The blower exhausts humid air from the drum through an exhaust outlet assembly to a discharge location exterior of the cabinet. Typically, the exhaust outlet assembly comprises a flexible conduit fabricated of wire-reinforced plastic or segmented metal installed between the cabinet and the discharge location.

Efficient, economical operation of the dryer and drying of the clothing items requires unobstructed airflow through the drum and the exhaust outlet assembly. During installation of the dryer, particularly a consumer self-installation, the flexible conduit can become twisted, kinked, or obstructed so that the air flow therethrough is impeded. The user may also fail to clean the lint trap sufficiently, and lint may accumulate in the exhaust outlet assembly, particularly the flexible conduit. Finally, the air inlet can also become obstructed over time through the accumulation of dust and lint. These conditions can remain unrecognized or easily ignored by the user. Any of these conditions can reduce the airflow through the dryer, adversely affecting the drying of the clothing items, increasing the cost of operating the dryer, and increasing the potential for overheating and fire or premature failure of the dryer.

It would be desirable to have a dryer that can consistently and accurately evaluate the airflow conditions therethrough, alert the user that an undesirable condition exists, and provide information to a service technician relating to the condition and its correction.

### SUMMARY OF THE INVENTION

A clothes dryer comprises a rotating drum defining a clothes drying chamber, an air system for supplying air to the clothes drying chamber and exhausting air from the clothes drying chamber, a motorized blower for moving air from an inlet to the drying chamber, through the clothes drying chamber, and through an exhaust inlet, and a heater for heating the air. A method of operating the clothes dryer comprises determining a supply air flow parameter representative of the flow rate of the air supplied to the clothes drying chamber, determining an exhaust air flow parameter representative of the flow rate of the air exhausted from the clothes drying chamber, and determining a condition of the air flow through the air flow system based on the supply air flow parameter and the exhaust air flow parameter.

In another embodiment, the method comprises determining a supply air flow rate representative of the flow rate of the air supplied to the clothes drying chamber, and comparing the supply air flow rate to a predetermined air flow rate and determining a blockage based on the comparison.

### BRIEF DESCRIPTION OF THE DRAWINGS

In the drawings:

FIG. 1 is a perspective view of an automatic clothes dryer comprising a cabinet enclosing a rotating drum, a blower assembly, and a temperature sensor according to the invention.

FIG. 2 is a perspective view of the automatic clothes dryer illustrated in FIG. 1 with portions removed for clarity, illustrating the internal components.

FIG. 3 is a perspective view of the blower assembly, including an air heating assembly and temperature sensors, illustrated in FIG. 2.

FIG. 3A is a sectional view of the air heating assembly and temperature sensor of FIG. 3 taken along line 3A-3A.

FIG. 4 is a graphical representation of temperature change and temperature sensor output over time from a temperature sensor such as illustrated in FIG. 3.

FIG. 5 is a graphical representation of a variation in slope of the temperature sensor output curve of FIG. 4, illustrating the determination of an inflection value corresponding to the steepest slope.

FIG. 6 is a graphical representation of the relationship between starting temperature and air flow on the inflection value for the dryer of FIGS. 1-5.

FIG. 7 is a graphical representation of the relationship between starting temperature and inflection value on a calculated air flow through the dryer of FIGS. 1-5.

### DESCRIPTION OF AN EMBODIMENT OF THE INVENTION

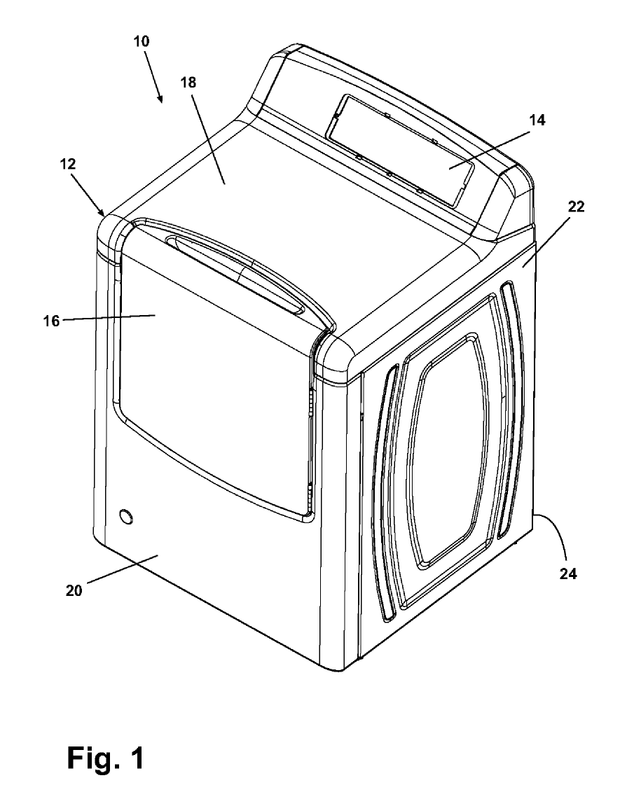

Referring to the Figures, and in particular to FIG. 1, an embodiment of an automatic clothes dryer 10 according to the invention is illustrated comprising a cabinet 12 having a control panel 14 for controlling the operation of the dryer 10, a door 16 hingedly attached to a front wall 20 of the cabinet 12, a rear wall 24, and a pair of side walls 22 supporting a top wall 18. The clothes dryer 10 described herein shares many features of a well-known automatic clothes dryer, and will not be described in detail except as necessary for a complete understanding of the invention.

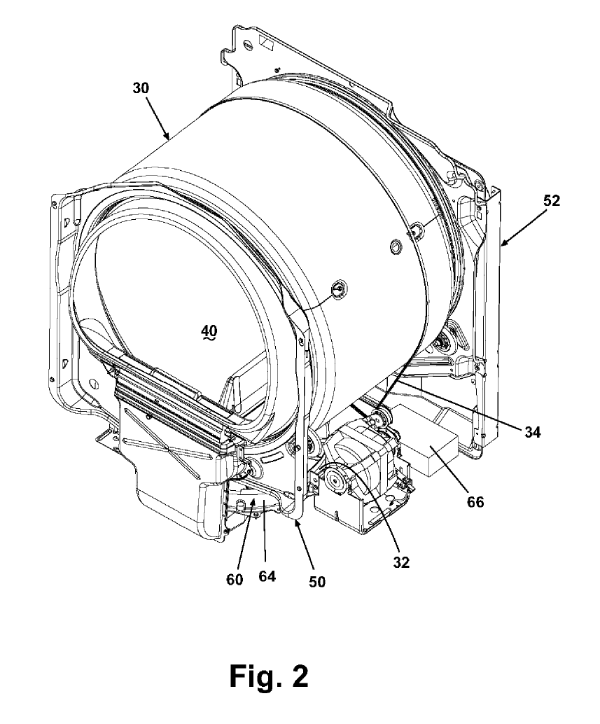

FIG. 2 illustrates the dryer 10 with the cabinet 12 removed to disclose the interior of the dryer 10, which comprises a rotating drum 30 rotatably suspended in a well-known manner between a front drum panel 50 and a rear drum panel 52. The front drum panel 50 is provided with an opening for access to the interior of the drum 30 which defines a drying chamber 40. The cabinet 12 also encloses a drum motor assembly 32 adapted in a well-known manner for rotating the drum 30 via a drum belt 34, and a blower assembly 60, which is partially visible beneath the drum 30.

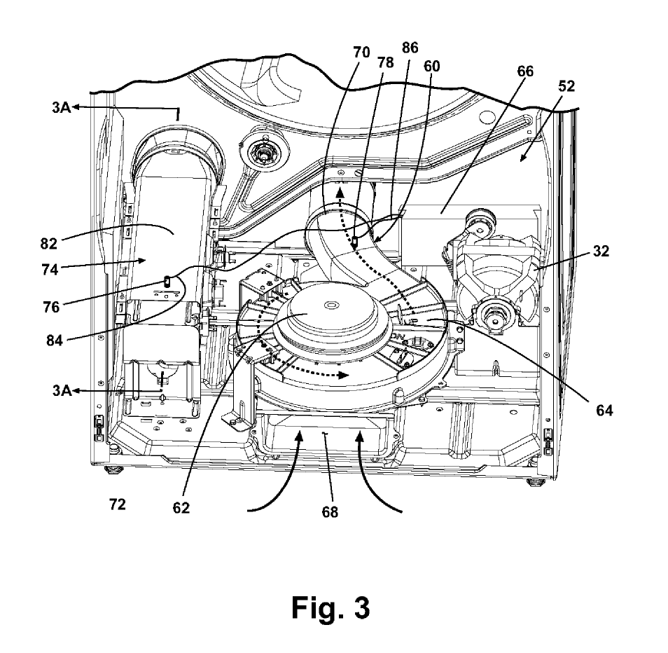

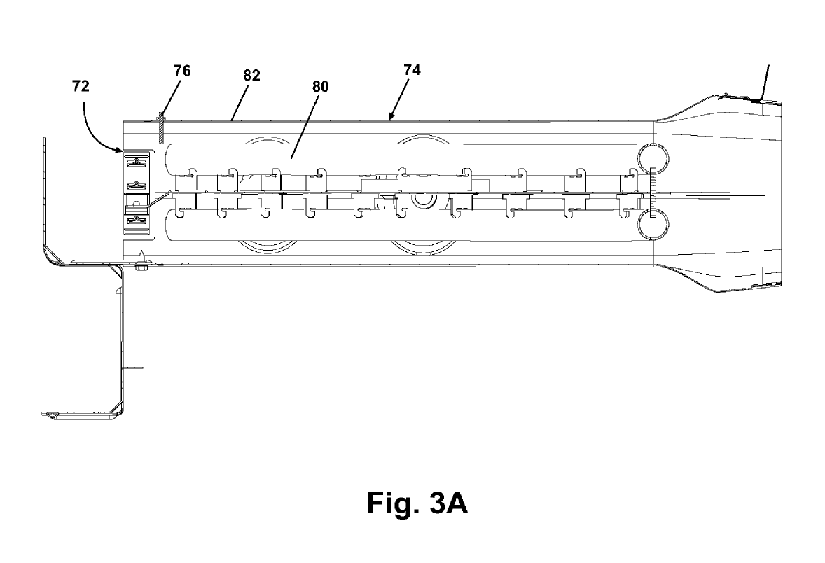

The blower assembly 60 is more clearly illustrated in FIG. 3, wherein the drum 30 is removed for clarity. The blower assembly 60 comprises a blower motor 62, a blower 64, and a controller 66. The blower 64 is illustrated as a centrifugal blower comprising a rotating impeller (not shown) enclosed in a housing which is configured to draw in air coaxially and exhaust the air tangentially in a direction orthogonal to the direction of air flow through the impeller. However, other blower types can be employed. Furthermore, the drum motor assembly 32 can be adapted to drive both the blower 64 and the drum 30, thereby eliminating the blower motor 62.

After passing through the drying chamber 40, air is drawn into the blower 64 through a blower inlet 68, as illustrated by the solid line flow vectors, and through the blower housing, as illustrated by the dotted line flow vectors, to exit a blower outlet 70 which is fluidly attached to a flexible dryer vent hose or similar conduit (not shown). Air entering the drying chamber 40 first passes through a dryer air inlet 72 entering into a heater assembly 74 for heating air prior to its entry into the drying chamber 40. The heater assembly 74 is fluidly connected to the drying chamber 40 through suitable inlet and outlet opening in the rear drum panel 52 and a connecting passageway. Thus, air is drawn through the inlet 72 into the heater assembly 74, and on into the drying chamber 40 by the blower assembly 60. The air then passes out of the drying chamber 40 through a passageway (not shown) in the front drum panel 50, through the blower assembly 60 to be exhausted through the dryer vent hose.

The heater assembly 74 is adapted for mounting of a conventional temperature sensor 76, such as a thermistor, for monitoring the temperature at a selected location within the heater assembly 74. In the embodiment described herein, the temperature sensor output is utilized to generate digital data that is proportional to the temperature.

Referring to both FIGS. 3 and 3A, the temperature sensor 76 is illustrated as mounted in a top wall 82 of the heater assembly 74 intermediate the inlet 72 and a heating element 80, i.e. upstream of the heating element 80. Alternatively, the temperature sensor 76 can be mounted downstream of the heating element 80, or in one of the other heater assembly walls. The mounting location of the temperature sensor 76 is selected in order to accurately sense the change in temperature during heating of the heating element 80 and the flow of air through the heater assembly 74.

A second temperature sensor 78 is similarly mounted in the blower assembly 60 intermediate the blower 64 and the blower outlet 70. Electrical leads 84, 86 from each sensor 76, 78, respectively, are connected to the controller 66. The controller 66 comprises a well-known control device, such as a microprocessor, digital memory for storing data from the temperature sensors 76, 78, and interfaces for suitable communication devices, such as displays, alarms, keypads, and the like.

The temperature sensors 76, 78 are utilized to determine air flow through the clothes dryer 10. The output from the temperature sensor 76 is utilized to determine air flow upstream of the drying chamber 40 in order to evaluate whether a blockage exists somewhere in the air flow path, such as the lint trap or exhaust hose. The output from the temperature sensor 78 in conjunction with blower motor data is utilized to determine air flow downstream of the drying chamber 40, and with the information provided from the upstream temperature sensor 76 is utilized to determine air leakage into the dryer 10, such as through seals or around the access door 16.

The airflow estimated from the temperature sensor output represents a volumetric flow rate in scfm units at the entrance to the heater assembly 74. To determine the air flow upstream of the drying chamber 40, prior to the initiation of a drying cycle, the heating element 80 is operated at maximum output, and a series of measurements of the output from the temperature sensor 76 is taken. In the embodiment described herein, measurements from the temperature sensor 76 are taken at one second intervals for a period of 30 seconds, and utilized in an algorithm to calculate the air flow upstream of the drying chamber 40. With a typical thermistor, the output from the thermistor will be an analog voltage which varies inversely with temperature. In the embodiment described herein, the processing of the output is completed in a computer-based controller. The analog output signal from the thermistor is converted in the controller to digital data, which is stored in a conventional memory.

The stored data is processed in a buffer memory, and used, along with preselected coefficients, in an air flow algorithm to calculate the flow value through the dryer. The following describes the methodology for determining the air flow value. The determination of an air flow value is performed electronically in the computer-based controller 66. However, for illustration purposes, the determination of the air flow value is described and illustrated with respect to graphical representations of the methodology.

The following air flow algorithm having the general form of a polynomial equation is utilized to determine air flow from the output of the temperature sensor 76:
Flow=a₀+a₁·ADₛₜₐᵣₜ+ . . . +a₂·ADₛₜₐᵣₜⁿ+a₃·ₛₗₒₚₑ+ . . . +a₄·AD_{diff}+a₅·AD_{diff}ⁿ+ . . . +a₆·Inflectionₛₗₒₚₑⁿ

where

Flow=volumetric flow rate, scfm;

Inflectionₛₗₒₚₑ=the minimum A/D slope from the inlet temperature sensor calculated using an overlapping scheme with 1 second sampling rate for filtering purposes, counts per second;

ADₘₐₓ=the A/D value of the maximum inlet temperature sensor reading sampled during the initiation of the air flow detection routine, counts;

ADₛₜₐᵣₜ=the A/D value of the inlet temperature sensor just before the heating element is turned on, counts;

AD_{diff}=the difference between ADₛₜₐᵣₜ and ADₘₐₓ=ADₘₐₓ−ADₛₜₐᵣₜ, counts.

“AD” refers to temperature sensor output data converted from an analog voltage into digital form for purposes of the embodiment described herein. It is a dimensionless value, and is processed in terms of counts. The air flow algorithm could be structured to utilize analog data, with appropriate modifications to the coefficients a₀-a₆. In either case, the methodology described herein would remain essentially the same.

The coefficients a₀-a₆ are machine specific, and dependent upon a particular combination of factors such as the blower, drying chamber, inlet and outlet air passageways, heater, and the like. The coefficients are developed from experimental characterization, and a well-known regression analysis of flow versus temperature data for a particular dryer configuration. Design and/or software changes to the dryer mechanical and electrical systems will require validation and/or re-characterization of the coefficients. Variations in dryer configuration, air flow capacity, heating element characteristics such as electric versus gas, and the like, will give rise to different coefficient values, which must be determined empirically for each dryer configuration.

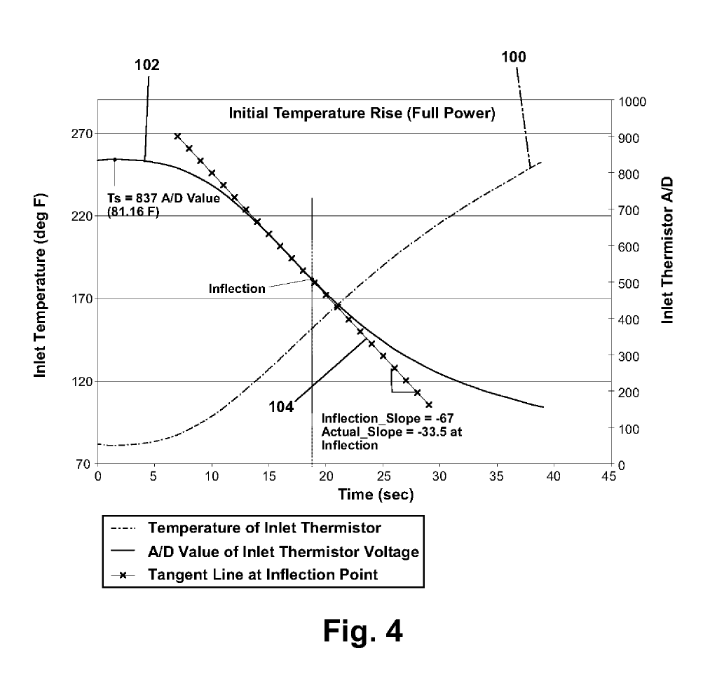

FIG. 4 illustrates the temperature rise experienced by the temperature sensor 76 as a result of operating the heating element 80 at full power. The temperature sensor 76 in this illustration is a conventional thermistor providing a voltage output which varies inversely with the change in temperature. The temperature curve 100 illustrates that the temperature rises from an initial value of 82° F. to a value after 39 seconds of 254° F. The temperature sensor output curve 102 indicates corresponding A/D values for the temperature sensor 76 as 862 and 161, respectively. The initial A/D value of 862 is equal to ADₛₜₐᵣₜ. The temperature sensor output curve 102 is initially concave downwardly, but transitions to a concave upwardly portion through an inflection point. In FIG. 4, this inflection point occurs at 1 g seconds. A tangent line 104 passing through the inflection point has a slope which can be readily determined graphically in a well-known manner, and is equal to −33.5 counts per second.

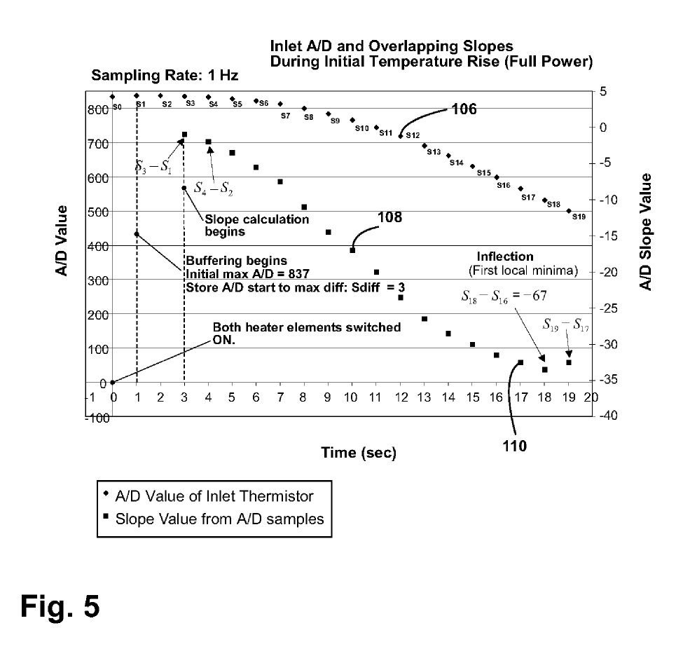

FIG. 5 illustrates the determination of Inflectionₛₗₒₚₑ from the temperature sensor data. The determination of Inflectionₛₗₒₚₑ can be done using a microprocessor and appropriate software. For purposes of illustration, FIG. 5 illustrates the process graphically.

The output from the temperature sensor 76 is determined at one second intervals, with the start time, t=0 sec corresponding to the heating element being switched on. The temperature sensor output value at the start time is measured, which is identified in FIG. 5 as so. Temperature sensor output values 106 are determined every second thereafter.

A review of FIGS. 4 and 5 will reveal a slight increase in the output value from the temperature sensor relatively early in the process. This reflects a slight decrease in the temperature of the temperature sensor from the starting temperature value, which is termed ADₛₜₐᵣₜ. In FIGS. 4 and 5, this is illustrated as occurring at about one second. This value is ADₘₐₓ, and is a result of air flow over the temperature sensor prior to heating of the heating element 80. The temperature then begins to rise, which is reflected in a decrease in the output value from the temperature sensor.

Beginning with ADₘₐₓ, a slope calculation is performed using the output values 106 from the temperature sensor. Digitized data from three consecutive output values from the temperature sensor is stored in a buffer, i.e. first, second, and third values, and the first value is subtracted from the third value. This difference is stored, and the next three consecutive output values from the temperature sensor are stored in the buffer; i.e. the second, third, and fourth values. The second value is subtracted from the fourth value and the difference is again stored. The differences are then compared. This process is repeated until the current difference value is less than the immediately prior difference value, which indicates that the rate of temperature increase is dropping. This is illustrated graphically in FIG. 5.

As illustrated in FIG. 5, slope values 108 are calculated based upon pairs of output values at two-second intervals, rather than one-second intervals, since it has been found that using the two-second intervals has a “filtering” effect which “smooths out” variations in the output values which can occur due to noise, voltage instability fluctuations, and other anomalies. For example, the first slope value, S₃−S₁, is calculated from the A/D values at three seconds and one second; the second slope value, S₄−S₂, is calculated from the A/D values at four seconds and two seconds. The process is repeated until a minimum slope value 110 is calculated. This is illustrated as the slope value S₁₈−S₁₆, which is equal to −67. Referring again to FIG. 4, this corresponds to the slope of the tangent line 104, which occurs at the inflection point and can be recognized as reflecting a minimum slope for the temperature sensor output curve 102.

The inflection point reflects the point at which the time rate of temperature change in the heater assembly 74 is greatest. If a blockage occurs in the air flow path, the time rate of temperature change would be expected to increase, the time rate of temperature sensor output change would be expected to increase, and the value of Inflectionₛₗₒₚₑ would be expected to decrease.

With the values of ADₛₜₐᵣₜ and ADₘₐₓ determined, AD_{diff} can be calculated. The value of Inflectionₛₗₒₚₑ will have been determined from the procedure described above. The air flow algorithm can then be utilized to calculate an air flow value. This calculated air flow value is then compared to a preselected threshold value. Based upon the results of this comparison, a decision is made whether to take corrective action, such as alerting the user, increasing the blower speed, shutting down the dryer, and the like.

The starting temperature, reflected in the temperature sensor output value ADₛₜₐᵣₜ, is significant for its effect on the rate of temperature change. The ADₛₜₐᵣₜ value is reflective in part of the ambient temperature conditions of the dryer. If the air flow determination described above is initiated immediately after a drying cycle, when the temperature of the dryer components are still elevated, the air flow algorithm must accommodate this difference in temperature conditions from the dryer in an unheated condition. This is accomplished through the utilization of ADₛₜₐᵣₜ.

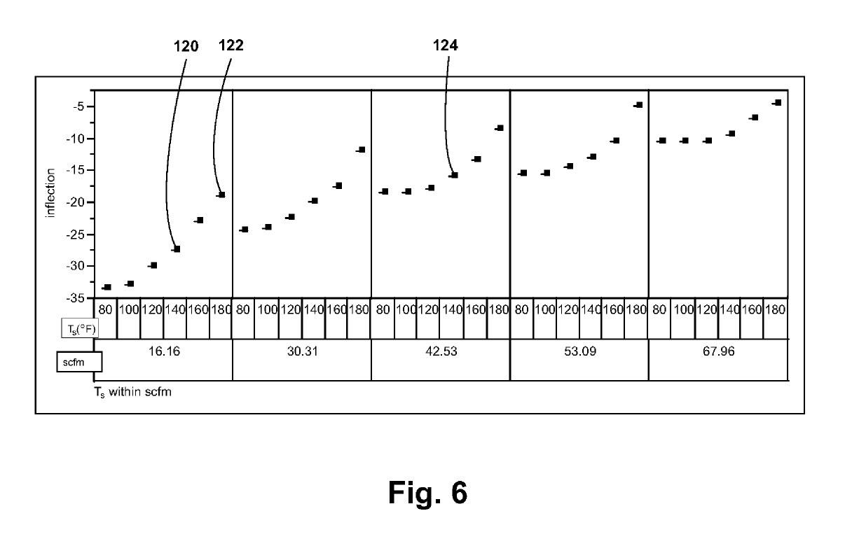

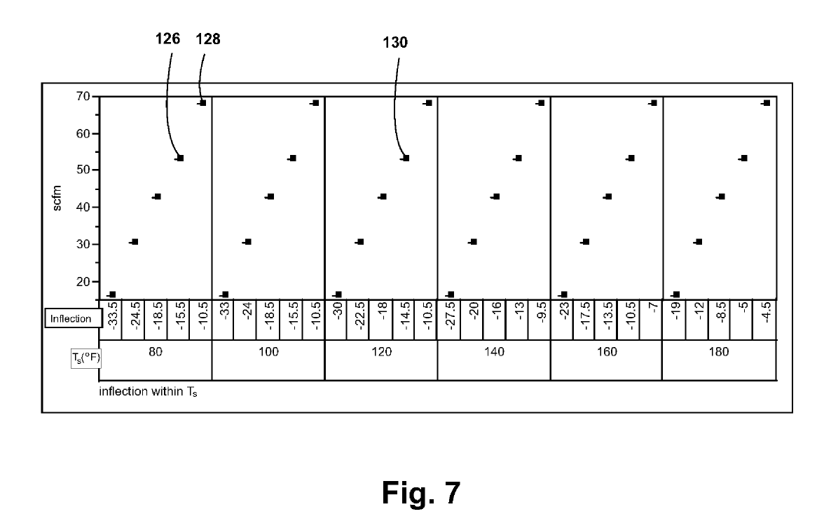

FIGS. 6 and 7 illustrate the effect of an initial elevated temperature on inflection. FIG. 6 illustrates the change in inflection for starting temperatures, Tₛ, ranging from 80° F. to 180° F. and airflow rates ranging from 16.16 to 67.96 cfm. At starting temperatures of 140° F. and 180° F., for an airflow rate of 16.16 cfm, the inflection value 120 changes from −25 to an inflection value 122 of −19. At a starting temperature of 140° F., a change in flow rate from 16.16 cfm to 42.53 cfm will result in a change in inflection value 120 from −25 to an inflection value 124 of −17.

FIG. 7 illustrates that at a starting temperature of 80° F., an inflection value of −15.5 will result in an air flow value 126 of 54 cfm, and an inflection value of −10.5 will result in an air flow value 128 of 69 cfm. At a starting temperature of 120° F., an inflection value 130 of −14.5 will also result in an air flow value of 54 cfm. Thus, the same air flow value will be calculated for differing inflection values based upon a difference in starting temperature, which can mask the existence of a blockage if the air flow algorithm does not account for starting temperature.

The difference between the starting temperature and the minimum temperature observed during the routine, as reflected in the calculated value AD_{diff}, is also significant for its effect on the rate of temperature change, as it represents additional information as to the thermal state of the dryer. If the air flow determination described above is initiated immediately after a drying cycle, when the temperature of the dryer components are still elevated, the air flow algorithm must accommodate this difference in temperature conditions from the dryer in an unheated condition. A decrease in temperature (increase in A/D values) can be observed for some period of time in these conditions which indicates the temperature device and the ambient air temperature are not at equilibrium. This adjustment can be accomplished through the utilization of AD_{diff} or ADₘₐₓ.

Detection of air leakage into the dryer requires an estimation of the airflow at the exhaust end of the airflow path, downstream of the blower. The airflow estimated represents a volumetric flow rate in scfm units at the exhaust end of the dryer.

The value of the volumetric flow rate downstream of the blower, FlOwₑₓₕₐᵤₛₜ, is determined from the blower motor operational characteristics and the output from the temperature sensor 78 according to the methodology described and illustrated in U.S. patent application Ser. No. 11/033,658, filed Jan. 12, 2005, entitled “Automatic Clothes Dryer,” which is fully incorporated by reference herein. The mass flow rate through the blower is first estimated. The mass flow rate can be determined directly from an air flow sensor, or indirectly from the blower motor speed, and the current delivered to or torque developed by the blower motor.

The mass flow rate is machine specific, and dependent upon a particular combination of factors such as the blower, drying chamber, inlet and outlet air passageways, heater, and the like. The mass flow rate can be developed from experimental characterization, including a well-known regression analysis for a particular dryer configuration. Design and/or software changes to the dryer mechanical and electrical systems will require validation and/or re-characterization of the coefficients. Variations in dryer configuration, air flow capacity, heating element characteristics such as electric versus gas, and the like, will give rise to different coefficient values, which must be determined empirically for each dryer configuration.

The volume flow rate is then calculated from the following relationship:

$${Flow}_{exhaust} = \frac{m}{ρ}$$

where the exhaust air density ρ (lbm/ft³) is estimated by a polynomial curve developed from a regression analysis of the relationship between exhaust air density and temperature (expressed as ADₑₓₕₐᵤₛₜ) for a particular dryer configuration. ADₑₓₕₐᵤₛₜ is the value of the AD output from an exhaust thermistor voltage divider.

The leakage volumetric flow rate mixing into the drum and/or blower can be calculated from the following relationship:
Leakᵢₙᵢₜᵢₐₗ=Flowₑₓₕₐᵤₛₜ−Flowᵢₙₗₑₜ

where

Leakᵢₙᵢₜᵢₐₗ=the leakage volume flow rate mixing into the drum and/or blower at the start of a dryer cycle, scfm;

Flowₑₓₕₐᵤₛₜ=the exhaust volume flow rate estimated from the above outlet thermistor airflow algorithm, scfm;

Flowᵢₙₗₑₜ=the inlet volume flow rate estimated from the above inlet thermistor airflow algorithm, scfm.

Subsequent flow changes made by changing blower motor speeds during the drying cycle effect the Flowᵢₙₗₑₜ estimate obtained by the inlet thermistor airflow algorithm at the beginning of the drying cycle. The Flowᵢₙₗₑₜ estimate can be adjusted by estimating the system leakage after each speed change and calculating a new inlet flow after each re-estimation of exhaust flow in accordance with the following relationship:

$$Leak = {Leak}_{initial} \cdot \frac{{Speed}_{current}}{{Speed}_{initial}}$$

where

Leak=the leakage volume flow rate mixing into the drum and/or blower at any time during the drying cycle, scfm;

Speed_{current}=the blower motor speed returned by the machine control unit;

Speedᵢₙᵢₜᵢₐₗ=the blower motor speed set point at the beginning of the cycle.

The blower motor speed, the motor torque or current data, and the temperature data can be processed and stored by an on-board computer system, which can perform the algorithms and evaluate the results for purposes of determining the existence of a blockage or leak. The results can be stored for later recovery and use by a service technician, and conveyed through audio and/or visual devices to the user.

The algorithms described herein enable the evaluation of air flow conditions through an automatic clothes dryer, such as blockages and leakage, with data developed from a simple temperature sensor. This eliminates the need for expensive and complex direct airflow measurement devices, which are costly to install and replace, and can themselves become ineffective if exposed to lint and other suspended particles in the dryer airflow.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

1. A method of operating a clothes dryer comprising a rotating drum defining a clothes drying chamber, an air system for supplying air to the clothes drying chamber and exhausting air from the clothes drying chamber, a motorized blower for moving air from an inlet to the drying chamber, through the clothes drying chamber, and through an exhaust inlet, and a heater for heating the air, the method comprising:
determining a supply air flow parameter representative of the flow rate of the air supplied to the clothes drying chamber;
determining an exhaust air flow parameter representative of the flow rate of the air exhausted from the clothes drying chamber; and
determining a condition of the air flow through the air flow system based on the supply air flow parameter and the exhaust air flow parameter.

2. The method according to claim 1, wherein the determining of the condition of the air flow comprises determining a blockage in the air flow system.

3. The method according to claim 1, wherein the determining of the condition of the air flow comprises determining leakage for the air flow system.

4. The method according to claim 1, wherein the supply air flow parameter is a temperature value of the air supplied to the clothes drying chamber.

5. The method according to claim 4, wherein the temperature value of the air supplied to the clothes drying chamber is determined from the maximum time rate of increase in the air temperature.

6. The method according to claim 1, wherein the exhaust air flow parameter is a temperature value of the air exhausted from the clothes drying chamber.

7. The method according to claim 6, wherein the flow rate of the air exhausted from the clothes drying chamber is determined from at least one of the speed, torque or current of the blower motor, and the temperature value of the air exhausted from the clothes drying chamber.

8. The method according to claim 1, and further determining an inflection value from a time rate of change of supply air temperature over a preselected time period.

9. The method according to claim 8, wherein the preselected time period occurs at the initiation of a drying cycle.

10. The method according to claim 8, and further determining the supply air temperature at regular time intervals.

11. The method according to claim 8 and further determining an initial supply air temperature value for determining with the inflection value the condition of the air flow through the air flow system.

12. The method according to claim 8, and further determining a minimum supply air temperature value for determining with the inflection value the condition of the air flow through the air flow system.

13. (canceled)

14. (canceled)

15. The method according to claim 4423, and further comprising determining an inflection value from a time rate of change of the temperature value of the air supplied to the clothes drying chamber over a preselected time period.

16. The method according to claim 15, and further comprising determining an initial temperature value of the air supplied to the clothes drying chamber for determining with the inflection value the condition of the air flow through the air flow system.

17. The method according to claim 15, and further comprising determining a minimum temperature value of the air supplied to the clothes drying chamber for determining with the inflection value the condition of the air flow through the air flow system.

18. The method according to claim 15, wherein the preselected time period occurs at the initiation of a drying cycle.

19. The method according to claim 15, and further comprising determining the supply air temperature at regular time intervals.

20. A method of determining a condition of the air flow in an air system for a clothes dryer comprising a rotating drum defining a clothes drying chamber, with the air flow system supplying and exhausting air from the clothes drying chamber, the method comprising:
determining a supply air flow parameter representative of the flow rate of the air supplied to the clothes drying chamber; and
determining a condition of the air flow through the air flow system based on the supply air flow parameter and the exhaust air flow parameter.

21. The method according to claim 20, wherein the determining of a condition comprises determining the presence of a flow restriction in the air flow system.

22. The method according to claim 21, wherein the determining of the presence of a flow restriction comprises the determining of at least a partial blockage in the air flow system.

23. The method according to claim 20, wherein the determining of the supply air flow parameter comprises determining a temperature value of the air supplied to the clothes drying chamber.
